(19) United States
(12) Patent Application Publication
(10) Pub. No.: US 2021/0215256 A1
(43) Pub. Date: Jul. 15, 2021

(54) VALVE CARTRIDGE ASSEMBLY FOR A FAUCET ASSEMBLY

(71) Applicant: THE BOEING COMPANY, Chicago, IL (US)

(72) Inventor: Jagdish Shinde, Bangalore (IN)

(21) Appl. No.: 16/742,267

(22) Filed: Jan. 14, 2020

(51) Int. Cl. F16K 3/26; F16K 31/60

(52) U.S. Cl. CPC F16K 3/267; B01D 27/07; F16K 31/605

(57) ABSTRACT

A valve cartridge assembly includes a rod member and a wall member, which defines a channel, which extends through the valve cartridge assembly and surrounds at least a portion of the rod member. A first portion of the channel has a first width dimension which is greater than a second width dimension of the rod member. A first end wall of wall member and the rod member define an inlet opening to first portion of channel. A seal member secured to the rod member, wherein the seal member has a third width dimension greater than a fourth width dimension of the inlet opening and with rod member and the seal member in a first position, seal member is positioned abutting against first end wall closing inlet opening and in a second position, seal member is positioned spaced apart from first end wall which places inlet opening in an open position.

### FIELD

This disclosure relates to a valve cartridge assembly and more particularly to a valve of the valve cartridge assembly, which controls water flow to a faucet outlet.

### BACKGROUND

Valve cartridge assemblies are known to utilize a float member as a valve for controlling flow of water through an inlet of the valve cartridge assembly so as to control flow of water out of an outlet of the valve cartridge assembly permitting the water to travel to a faucet outlet. The float member floats within a chamber, typically within the valve cartridge assembly, and the float member maintains the inlet blocked with being positioned against the inlet. The float member maintains a blocking position against the inlet with the float member floating in sufficient amount of water in the chamber to block the inlet or is otherwise pressurized with pressurized fluid positioned within the chamber such that float member maintains the inlet of the valve cartridge assembly blocked and closed with the faucet assembly not in use. At the time of use of the faucet assembly by a user, the float member is typically pushed downwardly with the user pushing a handle secured to a cartridge assembly of the faucet assembly, which in turn, pushes a rod downwardly within the valve cartridge assembly and onto the float member. As a result, the rod moves the float member out of blocking relationship with respect to the inlet of the valve cartridge assembly. With the float member pushed out of blocking relationship with respect to the inlet, pressurized water is permitted to flow through the valve cartridge assembly and out of an outlet of the valve cartridge assembly so as to ultimately flow to and out of the faucet outlet.

In instances where there is insufficient presence of fluid pressure within the valve cartridge assembly such that float member is not pushed against the inlet of the valve cartridge assembly, the float member is positioned out of blocking relationship with respect to the inlet. As a result, the inlet of the valve cartridge assembly is left in an open position. Unwanted material or debris, which originates from the faucet outlet can travel back through the faucet assembly and enter the valve cartridge assembly to the inlet of the valve cartridge assembly. The debris can inhibit the operation of the valve cartridge assembly and results in needed maintenance.

As a result, there is a need to provide reliable closure of the valve cartridge assembly inlet without relying upon presence of a fluid pressure being present within the valve cartridge assembly so as to float the buoyant float member to sufficiently maintain the inlet of the valve cartridge assembly in a closed position.

### SUMMARY

An example includes a valve cartridge assembly, which includes a rod member and a wall member, which defines a channel which extends through the valve cartridge assembly and surrounds at least a portion of the rod member. A first portion of the channel has a first width dimension which is greater than a second width dimension of the rod member and a first end wall of the wall member and the rod member define an inlet opening to the first portion of the channel. The valve cartridge assembly further includes a seal member secured to the rod member. The seal member has a third width dimension greater than a fourth width dimension of the inlet opening. With the rod and the seal member in a first position, the seal member is positioned abutting against the first end wall closing the inlet opening and in a second position, the seal member is positioned spaced apart from the first end wall which places inlet opening in an open position.

An example includes a method for using a valve cartridge assembly of a faucet assembly which includes moving a rod member within a channel between a first position and a second position. The channel is constructed of a wall member and the channel extends through the valve cartridge assembly. The rod member has a seal member secured to the rod member. A first portion of the channel has a first width dimension which is greater than a second width dimension of the rod member. A first end wall of the wall member and the rod member define an inlet opening to the first portion of the channel. The seal member has a third width dimension greater than a fourth width dimension of the inlet opening. With the rod member and the seal member in a first position, the seal member is positioned abutting against the first end wall closing the inlet opening and with the rod member moved to a second position, the seal member is positioned spaced apart from the first end wall which places inlet opening in an open position.

The features, functions, and advantages that have been discussed can be achieved independently in various embodiments or may be combined in yet other embodiments further details of which can be seen with reference to the following description and drawings.

### BRIEF SUMMARY OF THE DRAWINGS

FIG. 1 is a perspective view of a basin with a faucet assembly and a drain assembly;

FIG. 2 is a cross section view of the faucet assembly along line 2-2 of FIG. 1;

FIG. 3 is a cross section along 3-3 of FIG. 2 with the valve of the inlet of the valve cartridge assembly in a closed position;

FIG. 4 is a cross section of FIG. 3 with the valve of the inlet of the valve cartridge assembly in an open position;

FIG. 4A is an enlarged view of that which is encircled in FIG. 4 and labelled FIG. 4A;

FIG. 5 is an isolated perspective view of the valve cartridge assembly of FIG. 2;

FIG. 6 is an isolated perspective view of the cartridge assembly of FIG. 3; and

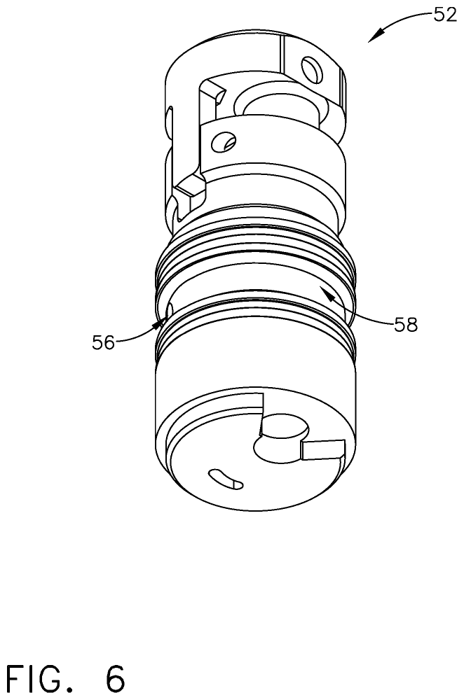

FIG. 7 is a flow chart of the method of use of a cartridge valve assembly.

### DESCRIPTION

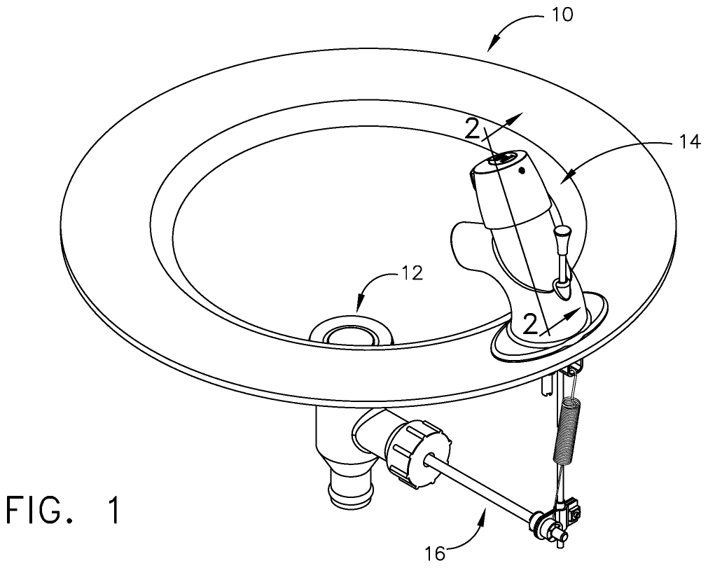

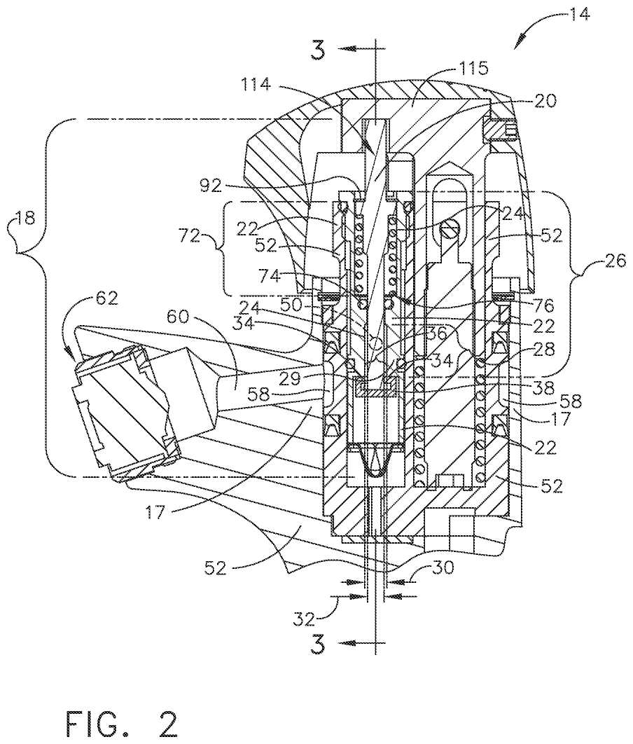

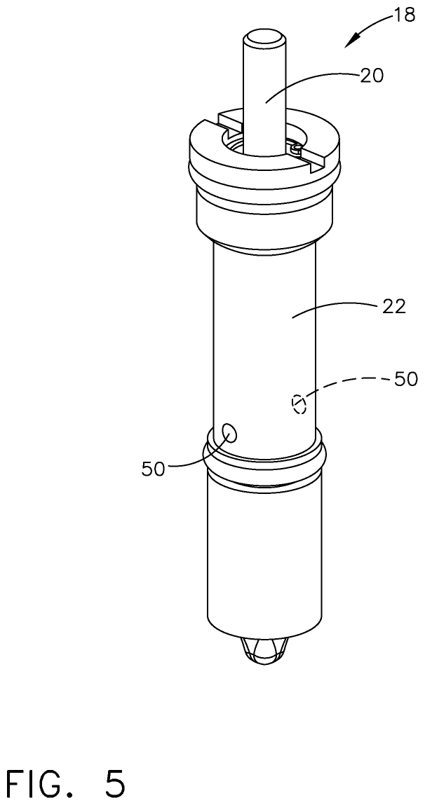

In referring to FIG. 1, basin 10 is shown with drain 12, faucet assembly 14 and drain opening and closing mechanism 16. There is a need to provide reliable closure of a valve cartridge assembly inlet, with the faucet assembly 14 not in use, without relying upon presence of a fluid pressure so as to float a buoyant float member and maintain an inlet of the valve cartridge assembly in a closed position. Reliable closure of valve cartridge assembly inlet is provided with valve cartridge assembly 18 discussed herein and seen in FIGS. 2-5.

In referring to FIG. 2, rod member 20 and wall member 22, wherein wall member defines channel 24 which extends through valve cartridge assembly 18 and surrounds at least a portion 26, as seen in FIGS. 2-4, of rod member 20. First portion 28 of channel 24 has a first width dimension 30 which is greater than second width dimension 32 of rod member 20. First end wall 34 of wall member 22 and rod member 20 define an inlet opening 36 to first portion 28 of channel 24.

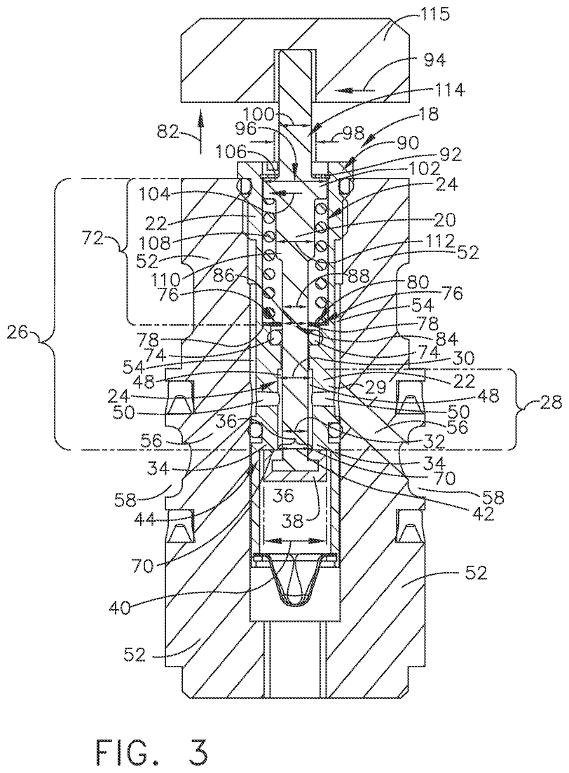

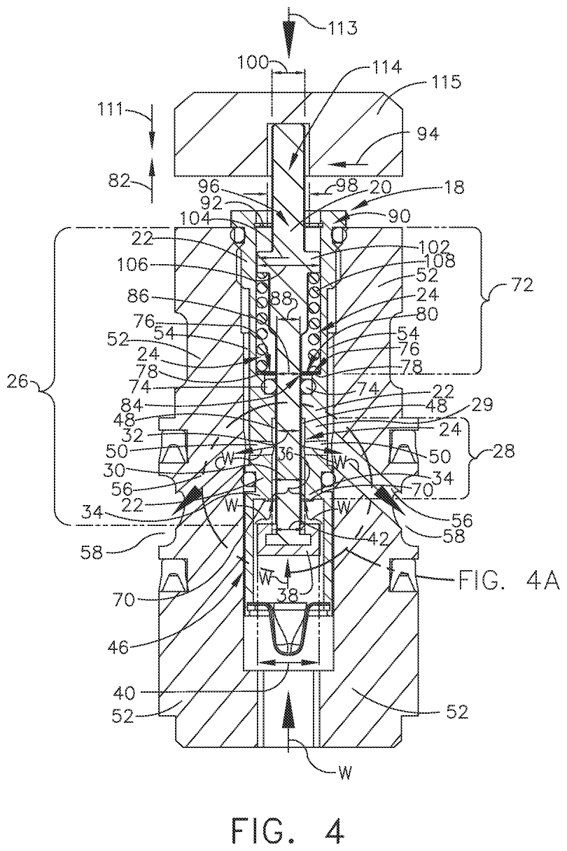

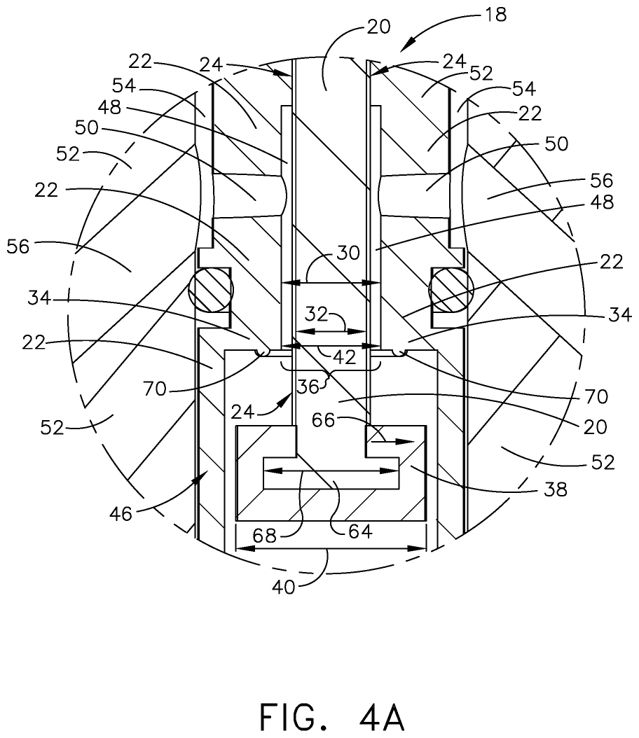

Seal member 38 is secured to rod member 20, wherein seal member 38 has third width dimension 40 greater than fourth width dimension 42 of inlet opening 36. With rod member 20 and seal member 38 in first position 44, as seen in FIG. 3, seal member 38 is positioned abutting against first end wall 34 closing inlet opening 36 and in second position 46, as seen in FIGS. 4 and 4A, seal member 38 is positioned spaced apart from first end wall 34 which places inlet opening 36 in an open position.

Rod member 20 and wall member 22 of first portion 28 of channel 24 define first space 48, as seen in FIGS. 3-4A, which is positioned between wall member 22 and rod member 20 and extends about and along the rod member 20. Inlet opening 36 is in fluid communication with first space 48. Wall member 22 within first portion 28 of channel 24 defines at least one outlet opening 50 through wall member 22 with at least one outlet opening 50 in fluid communication with first space 48. As seen in this example in FIGS. 3-5, there are two outlet openings 50 defined by wall member 22.

Valve cartridge assembly 18 is positioned within cartridge assembly 52, as seen in FIG. 2 of a faucet assembly 14. At least one outlet opening 50 is in fluid communication with first space 48 and a second space 54, which is defined between valve cartridge assembly 18 and cartridge assembly 52 as seen in FIG. 4A. Second space 54 is in fluid communication with at least one cartridge assembly channel 56, which is in fluid communication with an annular chamber 58 defined by housing 17 of faucet assembly 14 and the cartridge assembly 52, as seen in FIG. 2. Annular chamber 58 is in fluid communication with faucet outlet channel 60 defined by housing 17 of faucet assembly 14 and faucet outlet 62 is in fluid communication with faucet outlet channel 60. In this example, outlet opening 50 for valve cartridge assembly 18 is shown generally in alignment with cartridge assembly channel 56, however, with valve cartridge assembly 18 rotatable within cartridge assembly 52, outlet opening 50 may not be in alignment with cartridge assembly channel 56 and water outflowing from outlet opening 50 may flow within second space 54 about valve cartridge assembly 18 and between valve cartridge assembly 18 and cartridge assembly 52 until the water reaches cartridge assembly channel 56 and the water outflows to annular chamber 58, then to faucet outlet channel 60 and then to faucet outlet 62.

Rod member 20 is secured to seal member 38 wherein rod member 20 includes having first formation 64, as seen in FIG. 4A, which extends in direction 66 transverse to rod member 20 having fifth width dimension 68 greater than fourth width dimension 42 of inlet opening 36. Seal member 38 encapsulates first formation 64. Seal member 38 is constructed of one of a number of materials of which valves are constructed for faucet assemblies 14 that can readily form a water tight seal such as silicone, rubber based materials and the like. In this example, first end wall 34, as seen in FIG. 4A defines projection 70 which extends about rod member 20 and engages seal member 38 and provides a deformation of seal member 38 with rod member 20 and seal member 38 placed in first position 44 wherein inlet opening 36 is closed as seen in FIG. 3 and seal member 38 is biased against end wall 34 as will be discussed herein. This deformation of seal member 38 further provides a water tight closure.

Valve cartridge assembly 18 further includes second portion 72, as seen in FIGS. 2-4, of channel 24 which is positioned spaced apart from first portion 28 of channel 24 with seal 74 positioned between rod member 20 and wall member 22 such that seal 74 is positioned between first portion 28 of channel 24 and second portion 72 of channel 24. First end 76 of the second portion 72 is defined by a second end wall 78 of the wall member 22 which has surface 80 which faces in direction 82 away from first portion 28 of channel 24 and second end wall 78 defines a second end wall opening 84 having a sixth width dimension 86 greater than seventh width dimension 88 of rod member 20 which extends through second end wall opening 84. Second opposing end 90 of second portion 72 is defined by retainer wall member 92 which is secured to wall member 22, extends in a transverse direction 94 relative to wall member 22 and defines retainer wall member opening 96 having eighth width dimension 98 greater than ninth width dimension 100 of rod member 20 which passes through retainer wall member opening 96.

As seen in FIGS. 3 and 4, rod member 20 has second formation 102 which extends in direction 104 transverse to rod member 20 having tenth width dimension 106 that is greater than eighth width dimension 98 of the retainer wall member opening 96. Compression spring 108 is positioned within the second portion 72 of the channel 24 between second end wall 78 and second formation 102 of rod member 20. Compression spring 108 applies a force to second formation 102 positioning second formation 102 in abutting relationship to retainer wall member 92. At the same time, with seal member 38 and rod member 20 in first position 44, as seen in FIG. 3, compression spring 108 is applying a force on seal member 38 biasing seal member 38 against first end wall 34 to an extent in this example that projection 70 places a deformation in seal member 38 enhancing a water tight seal between first end wall 34 and seal member 38.

Portion 110 of rod member 20 positioned between second formation 102 and second end wall 78 and spaced apart from second end wall 78, has eleventh width dimension 112 greater than sixth width dimension 86 of second end wall opening 84 defined by second end wall 78, as seen in FIG. 3. Portion 114 of rod member 20 which extends through retainer wall member opening 96 and outside of second portion 72 of channel 24 engages cap member 115 such that when user applies a downward force 113, as seen in FIG. 4, second formation 102 applies a force onto compression spring 108 overcoming the spring force of compression spring 108. As a result, rod member 20 moves in a downward direction resulting in seal member 38 moving from closed first position 44, as seen in FIG. 3, to second position 46 which is open, as seen in FIG. 4. With second position 46 attained, water flows in direction of arrows “W” through valve cartridge assembly 18 and out of cartridge assembly 52, as seen in FIG. 4.

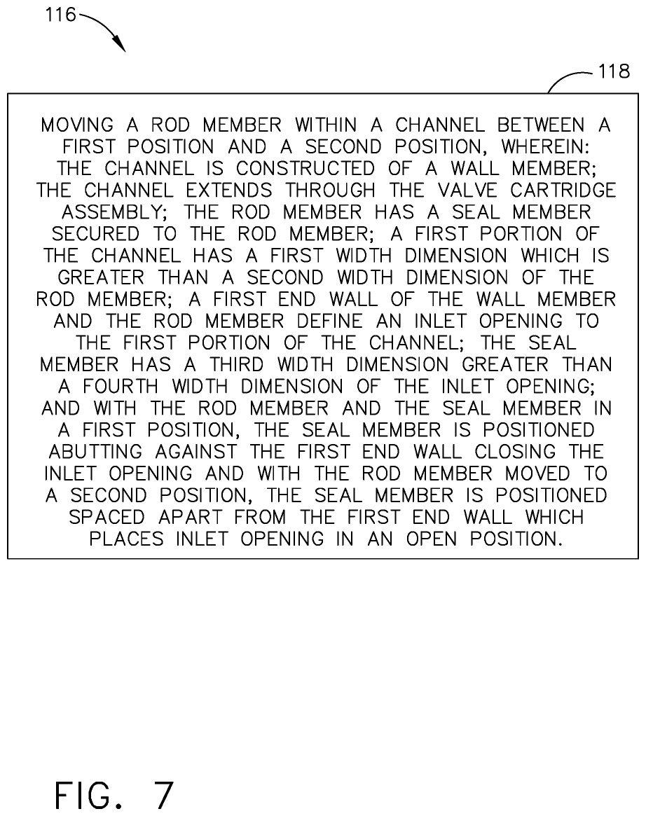

In referring to FIG. 7, method 116 for using valve cartridge assembly 18 of faucet assembly 14, which includes moving 118 rod member 20 within channel 24, which is constructed of and defined by wall member 22, between first position 44, which in this example is a closed position as seen in FIG. 3, and second positon 46 which in this example is an opened position as seen in FIG. 4. Channel 24 extends through valve cartridge assembly 18. Rod member 20 has seal member 38 secured to rod member 20, as discussed earlier. First portion 28 of channel 24 has first width dimension 30 which is greater than second width dimension 32 of rod member 20. First end wall 34 of wall member 22 and rod member 20 define an inlet opening 36 to first portion 28 of channel 24. Seal member 38 has third width dimension 40 greater than fourth width dimension 42 of inlet opening 36 and with rod member 20 and seal member 38 in a first position 44, seal member 38 is positioned abutting against first end wall 34 closing inlet opening 36, as seen in FIG. 3, and with rod member 20 moved to second position 46, as seen in FIGS. 4 and 4A, seal member 38 is positioned spaced apart from first end wall 34 which places inlet opening 36 in an open position.

Wall member 22 of first portion 28 of the channel 24 and rod member 20 define first space 48 with first space 48 extending about rod member 20 and along rod member 20. Inlet opening 36 is in fluid communication with first space 48. With moving rod member 20 and seal member 38 from first position 44 to second position 46, compression spring 108 associated with rod member 20 is further compressed. Rod member 20 includes first formation 64, which extends in direction 66 transverse to rod member 20 having fifth width dimension 68 greater than fourth width dimension 42 of inlet opening 36 and seal member 38 encapsulates first formation 64.

While various embodiments have been described above, this disclosure is not intended to be limited thereto. Variations can be made to the disclosed embodiments that are still within the scope of the appended claims.

1. A valve cartridge assembly, comprising:
a rod member;
a wall member which defines a channel which extends through the valve cartridge assembly and surrounds at least a portion of the rod member, wherein:
a first portion of the channel has a first width dimension which is greater than a second width dimension of the rod member;
a first end wall of the wall member and the rod member define an inlet opening to the first portion of the channel; and
the first end wall defines a projection, which extends about the rod member and extends away from the first end wall; and
a seal member secured to the rod member, wherein:
the seal member has a third width dimension greater than a fourth width dimension of the inlet opening;
with the rod member and the seal member in a first position, the seal member is positioned abutting against the first end wall in order to close the inlet opening, and the seal member also engages the projection, which provides a deformation of the seal member; and
with the seal member positioned in a second position, the seal member is positioned spaced apart from the first end wall in order to position inlet opening in an open position.

2. The valve cartridge assembly of claim 1, wherein:
the rod member and a portion of the wall member, which defines the first portion of the channel, define a first space, which is positioned between the portion of the wall member and the rod member and extends about and along the rod member; and
the inlet opening is in fluid communication with the first space.

3. The valve cartridge assembly of claim 2, wherein the portion of the wall member, which defines the first portion of the channel, defines at least one outlet opening through the portion of the wall member with the at least one outlet opening in fluid communication with the first space.

4. The valve cartridge assembly of claim 3, wherein:
the valve cartridge assembly is positioned within a cartridge assembly of a faucet assembly;
the at least one outlet opening is in fluid communication with the first space and a second space, which is defined between the valve cartridge assembly and the cartridge assembly;
the second space is in fluid communication with at least one cartridge assembly channel, which is in fluid communication with an annular chamber defined by a housing and the cartridge assembly; and
the annular chamber is in fluid communication with a faucet outlet channel defined by a housing of the faucet assembly and a faucet outlet is in fluid communication with the faucet outlet channel.

5. The valve cartridge assembly of claim 1, wherein the rod member is secured to the seal member, and includes the rod member having a first formation which extends in a direction transverse to the rod member having a fifth width dimension greater than the fourth width dimension of the inlet opening.

6. The valve cartridge assembly of claim 5, wherein the seal member encapsulates the first formation.

7. (canceled)

8. The valve cartridge assembly of claim 1, further includes a second portion of the channel which is spaced apart from the first portion of the channel with a rod seal positioned between the rod member and the wall member such that the seal is positioned between the first portion of the channel and the second portion of the channel.

9. The valve cartridge assembly of claim 8, wherein a first end of the second portion is defined by a second end wall of the wall member which has a surface which faces in a direction away from the first portion of the channel and the second end wall defines a second end wall opening having a sixth width dimension greater than a seventh width dimension of the rod member which extends through the second end wall opening.

10. The valve cartridge assembly of claim 9, wherein a second opposing end of the second portion is defined by a retainer wall member which is secured to the wall member, extends in a transverse direction relative to the wall member and defines a retainer wall member opening having an eighth width dimension greater than a ninth width dimension of the rod member which passes through the retainer wall member opening.

11. The valve cartridge assembly of claim 10, wherein the rod member has a second formation which extends in a direction transverse to the rod member having a tenth width dimension that is greater than the eighth width dimension of the retainer wall member opening.

12. The valve cartridge assembly of claim 11, wherein a compression spring is positioned within the second portion of the channel between the second end wall and the second formation of the rod member.

13. The valve cartridge assembly of claim 12, wherein the compression spring applies a force to the second formation positioning the second formation in an abutting relationship with the retainer wall member.

14. The valve cartridge assembly of claim 12, wherein a portion of the rod member, positioned between the second formation and the second end wall and spaced apart from the second end wall, has an eleventh width dimension greater than the sixth width dimension of a second end wall opening defined by the second end wall.

15. The valve cartridge assembly of claim 12, wherein a portion of the rod member which extends through the retainer wall member opening and outside of the second portion of the channel engages a cap member.

16. A method for using a valve cartridge assembly of a faucet assembly, comprising:
moving a rod member within a channel between a first position and a second position, wherein:
the channel is constructed of a wall member;
the channel extends through the valve cartridge assembly;
the rod member has a seal member secured to the rod member;
a first portion of the channel has a first width dimension which is greater than a second width dimension of the rod member;
a first end wall of the wall member and the rod member define an inlet opening to the first portion of the channel;
the seal member has a third width dimension greater than a fourth width dimension of the inlet opening;
the first end wall defines a projection, which extends about the rod member and extends away from the first end wall;
with the rod member and the seal member in the first position, the seal member is positioned abutting against the first end wall closing the inlet opening, and the seal member also engages the projection, which provides a deformation of the seal member; and
with the rod member moved to the second position, the seal member is positioned spaced apart from the first end wall which places the inlet opening in an open position.

17. The method of claim 16, wherein the wall member of the first portion of the channel and the rod member define a first space with the first space extending about the rod member and along the rod member.

18. The method of claim 17, wherein the inlet opening is in fluid communication with the first space.

19. The method of claim 16, wherein with moving the rod member and seal member from the first position to the second position, a compression spring associated with the rod member is further compressed.

20. The method of claim 16, wherein:
the rod member includes a first formation which extends in a direction transverse to the rod member having a fifth width dimension greater than the fourth width dimension of the inlet opening; and
the seal member encapsulates the first formation.

21. The method of claim 20, wherein:
a portion of the rod member extends through a retainer wall member; and
the rod member which extends through the retainer wall engages a cap member.
